(19) United States
(12) Patent Application Publication
(10) Pub. No.: US 2012/0087987 A1
(43) Pub. Date: Apr. 12, 2012

(54) COMBINED USE OF TWO INSECTICIDES

(75) Inventors: Victor F. Man, St. Paul, MN (US); S. John Barcay, Burnsville, MN (US); Darren M. Jahnke, Lonsdale, MN (US); Yvonne M. Killeen, South St. Paul, MN (US)

(73) Assignee: ECOLAB USA INC., St. Paul, MN (US)

(21) Appl. No.: 13/272,058

(22) Filed: Oct. 12, 2011

Related U.S. Application Data
(60) Provisional application No. 61/392,356, filed on Oct. 12, 2010.

(51) Int. Cl. A01N 41/04; A01N 65/06; A01N 65/24; A01N 65/08; A01N 65/28; A01P 7/00; A01N 63/02; A01N 65/42; A01N 65/22; A01N 59/08; A01N 65/20; A01N 59/16; A01N 65/18; A01N 65/44

(52) U.S. Cl. 424/529; 514/517; 424/776; 424/770; 424/739; 424/750; 424/754; 424/768; 424/747; 424/581; 424/745; 424/680; 424/757; 424/734; 424/641

(57) ABSTRACT

The present disclosure relates to the combined use of two pesticides. A first pesticide composition provides an initial contact kill, and may form a barrier when applied to greasy surfaces. A second pesticide composition provides residual pesticidal activity on the surface. Methods of making and using the pesticide compositions are also provided.

### CROSS-REFERENCE TO RELATED APPLICATIONS

This application claims priority to Provisional Application Ser. No. 61/392,356 filed Oct. 12, 2010, which is incorporated by reference herein in its entirety.

### FIELD OF THE INVENTION

The present disclosure relates generally to the field of pesticides. In particular, the present disclosure relates to the combined use of two insecticides.

### BACKGROUND

Left unattended, pests such as insects and rodents can quickly infest enclosed structures, such as restaurants and homes. Examples of pests which can infest areas in and around enclosed structures include cockroaches, ants, ground beetles and spiders. In addition to being a nuisance, some of these pests can also bring pathogens into the restaurant or home, creating unsanitary eating and living conditions. The use of pesticide compositions has aided in decreasing the infestation of insects in and around residential and commercial structures.

Various types of pesticide compositions and methods of repelling or terminating pests, e.g., arthropods, are currently available, including gel baits, glue pads and poisons. Because the pests can enter walls through small cracks and crevices and inhabit relatively inaccessible areas, such as within floors and behind walls, various tools can be used to “flush” the pests from the wall. For example, flushing agents can be sprayed into the areas to irritate or agitate the pests and cause them to leave the inaccessible areas and come out into the open and expose themselves. Once the pests enter the open environment, they are exposed to a pesticide composition that terminates them.

There is an ongoing need to provide effective pesticides.

### SUMMARY

In some aspects, the present invention provides methods for eliminating pests. The methods may comprise, consist of, or consist essentially of: (a) applying a first pesticide composition to an enclosed or partially enclosed area in a structure inhabited by pests; and (b) applying a second pesticide composition to the enclosed or partially enclosed area.

In some embodiments, the first pesticide composition is applied before the second pesticide composition is applied to the area. In other embodiments, the first pesticide composition is applied substantially simultaneously with the second pesticide composition to the area. In yet other embodiments, the first pesticide composition is allowed to substantially dry prior to applying the second pesticide composition to the area.

In other embodiments, the first pesticide comprises, consists of, or consists essentially of a surfactant pesticide. In yet other embodiments, the surfactant pesticide comprises sodium lauryl sulfate. In still yet other embodiments, the surfactant pesticide comprises about 1 wt % sodium lauryl sulfate. In some embodiments, the sodium lauryl sulfate is in liquid form.

In other embodiments, the second pesticide comprises, consists of, or consists essentially of a reduced risk pesticide.

In still yet other embodiments, at least one of the pesticide compositions is substantially free of phosphorous.

In other embodiments, the step of applying at least one of the pesticide compositions comprises spraying the pesticide composition. In still yet other embodiments, the first pesticide composition further comprises a co-surfactant.

In some aspects, the present invention provides methods of eliminating pests. The method may comprise, consist of, or consist essentially of: (a) mixing water and a solid form of sodium lauryl sulfate to form a first pesticide use solution effective in causing mortality in the pests, wherein the first pesticide use solution comprises, consists of, or consists essentially of between about 1% and about 10% by weight sodium lauryl sulfate; (b) applying the first pesticide use solution to an enclosed or partially enclosed area in a structure inhabited by the pests; and (c) applying a second pesticide composition to the enclosed or partially enclosed area.

In some embodiments, the sodium lauryl sulfate comprises between about 1% and about 6% by weight of the pesticide use solution. In other embodiments, the solid form of sodium lauryl sulfate is pellet form sodium lauryl sulfate. In still yet other embodiments, the solid form of sodium lauryl sulfate is needle form sodium lauryl sulfate. In some embodiments, the solid form of sodium lauryl sulfate is powder form sodium lauryl sulfate.

In some embodiments, the step of applying at least one of the pesticide compositions comprises spraying the pesticide composition. In other embodiments, the first pesticide composition further comprises a co-surfactant. In still yet other embodiments, the first pesticide composition is allowed to substantially dry before the second pesticide composition is applied.

In other embodiments, the second pesticide comprises a reduced risk pesticide.

In other embodiments, the pest is an arthropod.

### DETAILED DESCRIPTION

In some aspects, the present disclosure relates to the combined use of two pesticides. A first pesticide composition includes a surfactant pesticide. The first pesticide composition may provide an initial contact kill, and may also act as a barrier when applied to a greasy surface. The barrier forming properties of the first composition increase the efficacy of a second pesticide composition applied to the same surface. That is, the use of a first surfactant pesticide composition increases the grease compatibility of a second pesticide composition applied to the same surface. In some embodiments, the second pesticide composition provides residual kill.

So that the invention may be more readily understood certain terms are first defined.

As used herein, “weight percent,” “wt %,” “percent by weight,” “% by weight,” and variations thereof refer to the concentration of a substance as the weight of that substance divided by the total weight of the composition and multiplied by 100. It is understood that, as used here, “percent,” “%,” and the like are intended to be synonymous with “weight percent,” “wt-%,” etc.

As used herein, the term “about” refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes a composition having two or more compounds. It should also be noted that the term “or” is generally employed in its sense including “and/or” unless the content clearly dictates otherwise.

In some aspects, the present disclosure relates to methods of eliminating pests. The methods include applying a first pesticide composition to an enclosed or partially enclosed area, and applying a second pesticide composition to the enclosed or partially enclosed area. The pesticide compositions include those that kill or control a variety of pests. Pests killed or controlled by the compositions and methods disclosed herein include, but are not limited to, arthropods, e.g., insects, arachnids, crustaceans, and others. Pests killed or controlled by the compositions include, but are not limited to: cockroaches and any other crawling pests, such as, for example, ants, ground beetles, spiders, bed bugs, and the like; and flying pests and their larvae and eggs.

The pesticide compositions may be employed at any of a wide variety of locations in which it is desired to eliminate pest infestation. The pesticide compositions are effective in killing pests, e.g., arthropods. In addition, the pesticide compositions are generally more ecologically sustainable than traditional pesticides, making them particularly useful where it is desired to use environmentally friendly pesticides. Such applications include using the pesticide compositions in and around restaurants, stores, homes, or other generally enclosed structures in which humans and animals are present. In addition, while the pesticide compositions are discussed as being applied to and around partially enclosed or enclosed areas, the pesticide composition may also be used in an agricultural environment.

The pesticide compositions may include concentrate compositions or may be diluted to form use compositions. In general, a concentrate refers to a composition that is intended to be diluted with water or other diluent to provide a use solution that contacts an object to provide the desired effect. The pesticide compositions that contact the pests or surrounding areas can be referred to as the use compositions. The use solutions can include additional functional ingredients. The use solutions can have a solids content that is sufficient to provide the desired level of efficacy while avoiding wasting the pesticide compositions. The solids concentration refers to the concentration of the non-water components in the use composition.

In some aspects, the methods include applying a first pesticide composition. The first pesticide composition can include a surfactant pesticide composition. As used herein, the term “surfactant pesticide” refers to a pesticide which also has surfactant properties. That is, a surfactant pesticide refers to a compound or composition which has the ability to kill or control pests, e.g., arthropods, and also has the ability to reduce or lower the surface tension of a liquid with which the compound or composition comes into contact with. The surfactant pesticides for use in the present invention may also form a barrier on a greasy surface. Without wishing to be bound by any particular theory, it is thought that by providing a barrier on a greasy surface, the surfactant pesticides improve or enhance the grease compatibility of other non-surfactant pesticides applied to the same surface.

Examples of surfactant pesticides include nonionic surfactants, semi polar nonionic surfactants, cationic surfactants, amphoteric surfactants, zwitterionic surfactants and combinations thereof. In some embodiments, the surfactant pesticide is selected from the group consisting of sodium lauryl sulfate, alcohol ethoxylates, quaternary ammonium compounds, fatty acids, twin-tailed surfactants such as dioctylsulfosuccinate, and mixtures thereof. Preferred surfactant pesticides include a hydrophobic portion with from about 6 to about 16 carbon atoms, or about 8 to 14, or about 10 to 12 carbon atoms. Sodium lauryl sulfate is a surfactant pesticide that is highly soluble in water, e.g., 250 g/L at 20° C.

In other embodiments, the first pesticide composition of the present invention includes a combination of sodium lauryl sulfate (SLS) and water. Suitable component concentrations for a concentrate of the pesticide composition include between about 90% and about 100% sodium lauryl sulfate by weight and balance water, particularly between about 93% and about 100% sodium lauryl sulfate by weight and balance water and more particularly between about 95% and about 100% sodium lauryl sulfate by weight and balance water. Suitable component concentrations for a use solution of the first pesticide composition including SLS include between about 1% and about 10% sodium lauryl sulfate by weight and balance water and particularly between about 1% and about 6% sodium lauryl sulfate by weight and balance water. At concentrations higher than about 12% by weight sodium lauryl sulfate, solid form sodium lauryl sulfate may not effectively form a solution. In other embodiments, similar intermediate concentrate and use concentrations may also be present in the pesticide compositions of the invention.

Examples of suitable solid forms of sodium lauryl sulfate include, but are not limited to, powder, pellet, and block forms. An example of a particularly suitable pellet form of sodium lauryl sulfate is needle form sodium lauryl sulfate. An example of a suitable commercially available needle form sodium lauryl sulfate includes Stepanol DX®, CAS number 151-21-3, available from Stephan Company, Northfield, Ill. While both powder form and pellet form sodium lauryl sulfate may be used to form the pesticide composition, pellet form sodium lauryl sulfate is generally easier to handle and does not become airborne as easily as other solid forms.

When liquid concentrate form sodium lauryl sulfate is used as the first pesticide composition, suitable component concentrations include between about 1% and about 18% sodium lauryl sulfate by weight and balance water and particularly between about 6% and about 18% sodium lauryl sulfate by weight and balance water.

Because sodium lauryl sulfate is on the §25(b) exempt list of minimum risk pesticides published by the Environmental Protection Agency (“EPA”) in the Federal Insecticide, Fungicide, and Rodenticide Act (“FIFRA”), the pesticide compositions are ecologically acceptable. In some embodiments, the first pesticide composition includes an effective amount of sodium lauryl sulfate and water. In other embodiments, the first pesticide composition further includes additional components that are on the list of minimum risk pesticides and/or materials that are otherwise considered ecologically safe, non-toxic or food grade. For example, in some embodiments, the first pesticide composition does not include components which may be considered toxic or carcinogenic when exposed to humans. In other embodiments, the first pesticide composition contains conventional pesticides or other components in concentrations of less than about 0.5% by weight of a use solution of the pesticide composition, particularly less than about 0.1% by weight of a use solution of the pesticide composition and more particularly less than about 0.01% by weight of a use solution of the pesticide composition. In still yet other embodiments, the pesticide composition includes conventional pesticides at lower concentrations than typically required when used as the primary pesticide due to the presence of the sodium lauryl sulfate.

In some aspects, the methods further include applying a second pesticide composition. In some embodiments, a reduced or minimum risk pesticide, as defined by the EPA, is included as the second pesticide. Reduce risk pesticides include pesticides with characteristics such as very low toxicity to humans and non target organisms, including fish and birds, low risk of ground water contamination or runoff, and low potential for pesticide resistance. Exemplary active ingredients for reduced risk pesticides include but are not limited to, castor oil, cedar oil, cinnamon and cinnamon oil, citric acid, citronella and citronella oil, cloves and clove oil, corn gluten meal, corn oil, cottonseed oil, dried blood, eugenol, garlic and garlic oil, geraniol, geranium oil, lauryl sulfate, lemon grass oil, linseed oil, malic acid, mint and mint oil, peppermint and peppermint oil, 2-phenethyl propionate (2-phenyethyl propionate), potassium sorbate, putrescent whole egg solids, rosemary and rosemary oil, sesame and sesame oil, sodium chloride, sodium lauryl sulfate, soybean oil, thyme and thyme oil, white pepper, zinc metal strips, and combinations thereof.

In some embodiments, the second pesticide includes an effective amount of a pesticide, viz., an amount effective to kill or control a targeted pest, e.g., arthropod. In some embodiments, the second pesticide includes about 10 wt % to about 90 wt %, about 20 wt % to about 80 wt %, or about 30 wt % to about 60 wt % of a pesticide.

In some embodiments, the second pesticide composition includes a residual kill pesticide. In some embodiments, the second pesticide composition includes a pesticide that has poor grease compatibility. As used herein the term “poor grease compatibility” refers to compounds and compositions that are hydrophobic and lipophilic, and tend to migrate into the grease layer that they come into contact with. Thus, they are not as efficacious against pests as those pesticides which have higher grease compatibilities. In some embodiments the use of the first contact kill insecticide helps the grease compatibility of the second residual kill pesticide.

In some embodiments, the first, second or both the first and second pesticide compositions are substantially free of phosphorous. As used herein, a composition that is “substantially free of phosphorus” refers to refers to a composition, mixture, or ingredient that does not contain phosphorus or a phosphorus-containing compound or to which phosphorus or a phosphorus-containing compound has not been added. Should phosphorus or a phosphorus-containing compound be present through contamination of a phosphorus-free composition, mixture, or ingredients, the amount of phosphorus shall be less than 0.5 wt %. More preferably, the amount of phosphorus is less than 0.1 wt %, and most preferably the amount of phosphorus is less than 0.01 wt %.

The first, second, or both the first and second pesticide compositions can include additional components or agents, such as additional functional materials. In other embodiments, the first and second pesticides can provide a large amount, or even all of the total weight of the pesticide compositions, for example, in embodiments having few or no additional functional materials disposed therein.

The functional materials provide desired properties and functionalities to the pesticide compositions. As used herein, the term “functional materials” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and a broad variety of other functional materials can be used.

One or both of the pesticide compositions can include attractants such as cockroach pheromones (e.g., sex attractants, aggregation pheromones) or food-based attractants (e.g., methylcyclopentenalone, maltol, fenugreek and other flavorings). When an attractant is included, the attractant can constitute between about 0.1% and about 5% by weight of the pesticide composition in which it is present.

One or both of the pesticide compositions can also optionally include humectants such as glycerol to slow evaporation and maintain wetness of the pesticide compositions after application. When a humectant is included, the humectant may constitute between about 0.5% and about 10% by weight of the pesticide composition in which it is included.

One or both of the pesticide compositions can also include a co-surfactant composition to reduce or prevent the drying of the pesticide compositions, and prolong the activity of the pesticide compositions. Further, it is thought that the inclusion of a co-surfactant can increase the insecticidal efficacy of the compositions. In some embodiments, exemplary co-surfactants include long-chain alcohols, amine oxides, guerbet alcohols, guerbet alcohol ethoxylates, protonated fatty acids, and twin-tailed surfactants such as dioctylsulfosuccinate. The co-surfactants preferably have a hydrophobic tail with a carbon chain length of from about 6 to 16, about 8 to 14, or about 10 to 12. When a co-surfactant composition is included, the co-surfactant composition can be present at a ratio of up to about 1:0.03, 1:0.5, 1:1, or 1:3 of the surfactant pesticide to the co-surfactant composition. The compositions can also include additional inert ingredients. In some embodiments, the compositions include only additional inert ingredients that can be included in reduced/minimum risk pesticide products exempted under Section 25(b) of the FIFRA.

Packaging

The pesticide compositions may be packaged by any conventional means known in the art. For example, the selected pesticide and other functional ingredients may be premixed and packaged as a concentrate in a bucket. Alternatively, the pesticide compositions may be packaged in a water-soluble sachet for easy disposal after use and reduced packaging waste.

Methods of Use

In some aspects, the present disclosure relates to methods for eliminating pests. The methods include applying a first pesticide composition to an enclosed or partially enclosed area in a structure inhabited by pests, and applying a second pesticide composition to the area. The first and second pesticide compositions can be applied to the area in any order. For example, in some embodiments, the first pesticide composition is applied before the second pesticide composition is applied to the area. In other embodiments, the first pesticide composition is applied substantially simultaneously with the second pesticide composition to the area.

The pesticide compositions can be applied as separate pesticide compositions. In other embodiments, the pesticide compositions can be mixed together prior to application. When applied separately, the first applied pesticide composition can remain on the surface for a sufficient amount of time such that it dries prior to application of the second pesticide composition. In other embodiments, the first applied pesticide composition is not allowed to dry prior to the application of the second pesticide composition.

The pesticide compositions can be applied to the desired surfaces in any suitable method generally known. For example, the pesticide compositions can be sprayed, foamed, spread, rolled, misted, fogged, or poured on to the selected surface.

In some embodiments, the first, second, or both the first and the second pesticide compositions are provided as concentrates. The concentrates can be diluted with water at the location of use to provide the use solution. Once the pesticide concentrate compositions have been thoroughly diluted and mixed to form a substantially homogeneous solution, the pesticide compositions may be applied onto a surface, e.g., as a spray or foam or thickened liquid.

In other embodiments, the first pesticide composition is formed by mixing a diluent, e.g., water, and a solid form of sodium lauryl sulfate to form a first pesticide use solution. The first pesticide use solution can then be applied to the selected surface, before, or substantially simultaneously with the second pesticide composition. In other embodiments, the first pesticide use solution can be formed, and then mixed with the second pesticide composition prior to application to the surface.

The pesticide compositions are applied onto the surface for an amount of time sufficient to terminate the pests. The pesticide compositions can be applied in and around areas such as apartment buildings, bakeries, beverage plants, bottling facilities, breweries, cafeterias, candy plants, canneries, cereal processing and manufacturing plants, cruise ships, dairy barns, poultry facilities, flour mills, food processing plants, frozen food plants, homes hospitals, hotels, houses, industrial buildings, kennels, kitchens, laboratories, manufacturing facilities, mausoleums, meat processing and packaging plants, meat and vegetable canneries, motels, nursing homes, office buildings, organic facilities, restaurants, schools, stores, supermarkets, warehouses and other public buildings and similar structures. In particular, the pesticide compositions can be applied to surfaces, such as floors, where pests may harbor, including cracks, crevices, niches, dark areas, drains, and other harborage sites.

The pesticide compositions can also be used in methods for controlling insects, arachnids, and mites. The method includes allowing an effective amount of the pesticide compositions to act on the insects, arachnids, and/or mites.

The present disclosure may be better understood with reference to the following examples. These examples are intended to be representative of specific embodiments of the disclosure, and are not intended as limiting the scope of the disclosure.

### EXAMPLES

### Example 1

Example 1 tested the pesticidal efficacy of combinations of pesticides. The example first looked at the pesticidal properties in a wet panel forced exposure test to determine the efficacy of the pesticide on contact. Then the example looked at the pesticidal properties in a dry panel forced exposure test to determine the residual efficacy of the pesticide.

For the wet panel forced test, 20 adult male German cockroaches are placed on a stainless steel panel. The panel with the cockroaches are placed in a spray tower and sprayed with the pesticide for 60 seconds, starting when the spray comes into contact with the surface of the panel. The cockroaches are removed from the panel and placed in a jar with food and water. The jar is then observed for mortality at certain time intervals post-exposure.

For the dry panel test, panels are prepared by spraying the pesticide on the panel and allowing the panel to dry. Then 20 adult male German cockroaches are placed on the panel and allowed to remain on the panel for 60 seconds. The cockroaches are removed from the panel and placed in a jar with food and water. The jars are observed for mortality at certain time intervals post-exposure.

For the tests, some combinations of pesticides were mixed together right before application and applied together. Others were tested separately, as if they were applied sequentially. In other words, the Wet Forced Exposure Test was used to test the contact kill pesticide and the Dry Forced Exposure Test was used to test the residual kill pesticide. Only the contact kill pesticide was sprayed on the cockroaches in the wet test.

TABLE 1
Mortality Over Time Using the Wet Forced Exposure Test

| | 1 | 5 | 15 | 30 | 1 | 2 | 24 |
|---|---|---|---|---|---|---|---|
| | min. | min. | min. | min. | hour | hours | hours |
| Finito + Tempo Tank | 75.00 | 88.33 | 100.00 | 100.00 | 100.00 | 100.00 | 100.00 |
| Mixed | | | | | | | |
| Finito + Tempo Applied | 70.00 | 86.67 | 88.33 | 91.67 | 91.67 | 91.67 | 93.33 |
| Sequentially (2 Step) | | | | | | | |
| SLS + Tempo Tank | 0.00 | 70.00 | 98.33 | 100.00 | 100.00 | 100.00 | 100.00 |
| Mixed | | | | | | | |
| SLS + Tempo Applied | 0.00 | 0.00 | 0.00 | 0.00 | 0.00 | 0.00 | 0.00 |
| Sequentially (2 Step) | | | | | | | |
| Tempo SC Ultra | 0.00 | 26.67 | 100.00 | 100.00 | 100.00 | 100.00 | 100.00 |
| Water | 0.00 | 0.00 | 0.00 | 0.00 | 0.00 | 0.00 | 0.00 |

Table 1 shows that 100% of the cockroaches were killed when a contact kill pesticide and a residual kill pesticide are mixed together before applying. When applied sequentially, the contact kill and residual kill are capable of substantially reducing the number of cockroaches. Finito is a pesticide commercially available from Ecolab Inc., St. Paul, Minn. and Tempo is a pesticide commercially available from Bayer Professional Care.

TABLE 2
Mortality Over Time Using the Dry Forced Panel Test

| | 1 | 2 | 24 | 48 | 72 | 2 |
|---|---|---|---|---|---|---|
| | Hour | Hour | Hour | Hour | Hour | weeks |
| Finito + Tempo | 36.67 | 36.66 | 88.33 | 90.00 | 93.33 | 96.67 |
| Tank Mixed | | | | | | |
| Finito + Tempo | 41.67 | 41.66 | 98.33 | 100.00 | 100.00 | 100.00 |
| 2 Step | | | | | | |
| SLS + Tempo | 68.33 | 68.33 | 95.00 | 100.00 | 100.00 | 100.00 |
| Tank Mixed | | | | | | |
| SLS + Tempo | 58.33 | 58.33 | 96.67 | 100.00 | 100.00 | 100.00 |
| 2 Step | | | | | | |
| Tempo SC | 100.00 | 100.00 | 100.00 | 100.00 | 100.00 | 100.00 |
| Ultra | | | | | | |
| Water | 0.00 | 0.00 | 0.00 | 0.00 | 0.00 | 0.00 |

Table 2 shows the residual efficacy of various combinations of pesticides. Some combinations do not achieve 100% kill under the dry test but do under the wet test, such as Finito plus Tempo Tank Mixed. This suggests that these combinations would make a good combination where one would provide strong contact kill and some residual kill as well. Preferred combinations achieve 100% kill under the wet test and the dry test which suggests that they would achieve 100% contact and residual kill.

### Other Embodiments

It is to be understood that while the invention has been described in conjunction with the detailed description thereof, the foregoing description is intended to illustrate, and not limit the scope of the invention, which is defined by the scope of the appended claims. Other aspects, advantages, and modifications are within the scope of the following claims.

In addition, the contents of all patent publications discussed supra are incorporated in their entirety by this reference.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

We claim:

1. A method for eliminating pests comprising:
(a) applying a first pesticide composition to an enclosed or partially enclosed area in a structure inhabited by pests, the first pesticide composition being a contact kill pesticide comprising
a surfactant pesticide selected from the group consisting of sodium lauryl sulfate, alcohol ethoxylates, quaternary ammonium compounds, fatty acids, fatty acid soaps, dioctylsulfosuccinate, and mixtures thereof and the surfactant pesticide has a hydrophobic portion with a carbon chain length of from about 6 to 16; and
a co-surfactant selected from the group consisting of long-chain alcohols, amine oxides, guerbet alcohols, guerbet alcohol ethoxylates, protonated fatty acids, dioctylsulfosuccinate, and mixtures thereof, and the co-surfactant has a hydrophobic portion with a carbon chain length of from about 6 to 16; and
(b) applying a second pesticide composition to the enclosed or partially enclosed area.

2. The method of claim 1, wherein the first pesticide composition is applied before the second pesticide composition is applied to the area.

3. The method of claim 1, wherein the first pesticide composition is applied substantially simultaneously with the second pesticide composition to the area.

4. The method of claim 1, wherein the first pesticide composition is allowed to substantially dry prior to applying the second pesticide composition to the area.

5. The method of claim 1, wherein the surfactant pesticide comprises sodium lauryl sulfate.

6. The method of claim 5, wherein the surfactant pesticide comprises about 1 wt % sodium lauryl sulfate.

7. The method of claim 6, wherein the sodium lauryl sulfate is in liquid form.

8. The method of claim 1, wherein the second pesticide comprises a reduced risk pesticide.

9. The method of claim 8, wherein reduced risk pesticide comprises an active ingredient selected from the group consisting of castor oil, cedar oil, cinnamon and cinnamon oil, citric acid, citronella and citronella oil, cloves and clove oil, corn gluten meal, corn oil, cottonseed oil, dried blood, eugenol, garlic and garlic oil, geraniol, geranium oil, lauryl sulfate, lemon grass oil, linseed oil, malic acid, mint and mint oil, peppermint and peppermint oil, 2-phenethyl propionate (2-phenyethyl propionate), potassium sorbate, putrescent whole egg solids, rosemary and rosemary oil, sesame and sesame oil, sodium chloride, sodium lauryl sulfate, soybean oil, thyme and thyme oil, white pepper, zinc metal strips, and combinations thereof.

10. The method of claim 8, wherein the second pesticide composition comprises about 0.01 wt % to about 1.0 wt % of a reduced risk pesticide.

11. The method of claim 1, wherein at least one of the pesticide compositions are substantially free of phosphorous.

12. The method of claim 1, wherein the step of applying at least one of the pesticide compositions comprises spraying the pesticide composition.

13. The method of claim 1, wherein the surfactant pesticide is present from about 1% to about 10% by weight.

14. The method of claim 13, wherein the first pesticide comprises between about 1% and about 6% by weight surfactant pesticide.

15. The method of claim 1, wherein the second pesticide composition comprises about 0.01 wt % to about 1.0 wt % of the pesticide.

16. The method of claim 1, wherein the pest is an arthropod.
